(19) United States
(12) Patent Application Publication
(10) Pub. No.: US 2018/0053590 A1
(43) Pub. Date: Feb. 22, 2018

(54) Selective magnet pick-up component

(71) Applicants: Jason John Sutton, Monterey, TN (US); Brody Scott Hug, Marquette, MI (US)

(72) Inventors: Jason John Sutton, Monterey, TN (US); Brody Scott Hug, Marquette, MI (US)

(21) Appl. No.: 15/242,575

(22) Filed: Aug. 21, 2016

(51) Int. Cl. H01F 7/20; H01F 7/02; B25B 11/00; B25J 1/02

(52) U.S. Cl. CPC H01F 7/206; H01F 7/0257; B25B 9/00; B25J 1/02; B25B 11/002

(57) ABSTRACT

Metal and other magnetized objects are often dropped into hard-to-reach, magnetic-rich places where a retrieval tool will often latch onto the surrounding metal, all but the target object. This makes the retrieval of the target object with an ordinary magnet very difficult or sometimes even impossible. The invention relates to a magnetic retrieval tool with a selectively on/off component, allowing the magnetic force to be exerted only when the target becomes localized. Said magnetic force or field, will be encapsulated either by shielding, or by a second magnet that will neutralize the magnetic field turning the magnet “off” until the object is reached.

### DETAILED DESCRIPTION

Metal and other magnetized objects are often dropped into hard-to-reach places.

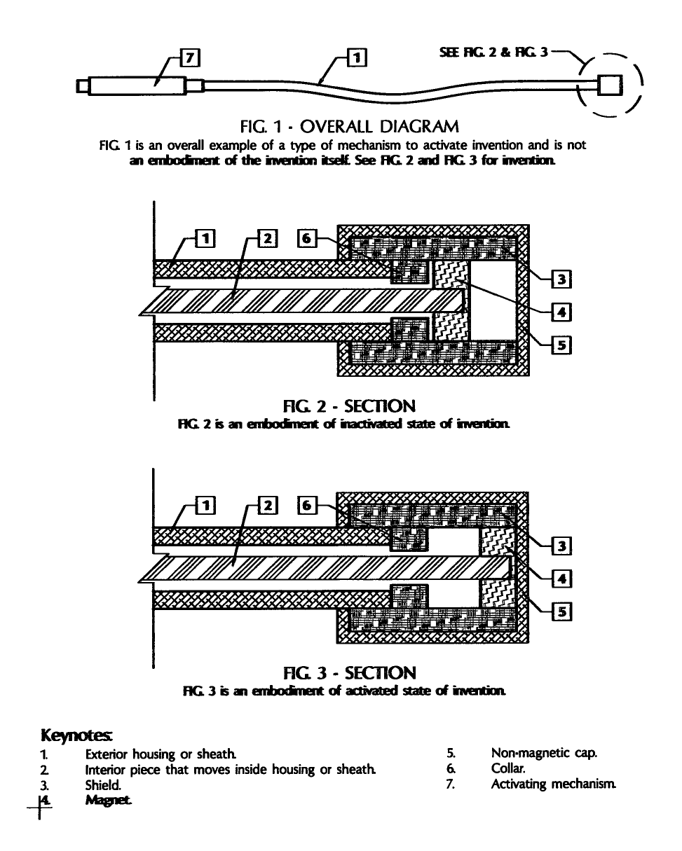

Often said places are also surrounded by other magnetized surfaces which makes retrieval with an ordinary magnet very difficult or impossible. This difficulty is partly due to the inability of said magnet to turn off until the target object is reached, and then “selectively” turn on and grab the object that is to be retrieved. The invention relates to a magnetic retrieval tool with a selectively on/off component, allowing the magnetic force to be exerted only when the target becomes localized. Said magnetic force or field will be encapsulated either by shielding or by a second magnet that will neutralize the magnetic field turning the magnet “off” until the object is reached. According to the drawings, FIG. 1 shows an overall diagram of the invention embodiment. FIGS. 2 and 3 show an embodiment of the inactivated verses activated state of the invention. Whereas the outside housing or sheath (1) comprises the exterior of the tool, the interior is a flexible and horizontally moveable shaft (2). Attached to the end of the outside housing (1) is a shield (3) which allows movement of the shaft (2) and the correspondingly-attached inside magnet (4) vertically. Surrounding and attached to the bottom portion of the shield (3) is the cap (5), which prevents attachment of debris or magnetized particles to the magnet. The proximal portion of said tool (7) can be configured with differing options based on preference.

1. A tool for retrieval of metal objects. Said tool includes a shaft and flexible outside sheath, wherein the improvement comprises: a plungeable shaft which moves vertically inside said housing; a non magnetized cap attached to the distal end of said housing; and a magnet attached to end of said shaft.

2. A tool for retrieving magnetized objects: wherein the improvement comprises the sum of all parts in claim 1, resulting in a selectively magnetized or unmagnetized component.
